(19) United States
(12) Patent Application Publication
(10) Pub. No.: US 2017/0016780 A1
(43) Pub. Date: Jan. 19, 2017

(54) THERMAL ANALYSIS METHOD, THERMAL ANALYSIS DEVICE, AND RECORDING MEDIUM STORING THERMAL ANALYSIS PROGRAM

(71) Applicant: FUJITSU LIMITED, Kawasaki-shi (JP)

(72) Inventors: Hiroki Kobayashi, Kawasaki (JP); Masayoshi Hashima, Kawasaki (JP)

(73) Assignee: FUJITSU LIMITED, Kawasaki-shi (JP)

(21) Appl. No.: 15/170,989

(22) Filed: Jun. 2, 2016

(30) Foreign Application Priority Data
Jul. 16, 2015 (JP) 2015-142004

(51) Int. Cl. G01K 13/00

(52) U.S. Cl. CPC G01K 13/00

(57) ABSTRACT

A thermal analysis method includes: setting, by a processor, a first node to a first component and second nodes to a second component from among components of an electronic device, based on design information of the electronic device; assigning thermal information including a second temperature and a second heat quantity to each of the second nodes, based on a first temperature and a first heat quantity of each of areas of the second component; calculating a first thermal resistance between adjacent nodes included in the second nodes, based on the thermal information; calculating a second thermal resistance between the first node and each of the second nodes, based on the design information to generate a thermal network including the first node, the second nodes, the first thermal resistance, and the second thermal resistance; and performing thermal analysis using the thermal network.

### CROSS-REFERENCE TO RELATED APPLICATION

This application is based upon and claims the benefit of priority of the prior Japanese Patent Application No. 2015-142004, filed on Jul. 16, 2015, the entire contents of which are incorporated herein by reference.

### FIELD

The embodiments discussed herein are related to a thermal analysis method, a thermal analysis device, and a program.

### BACKGROUND

When an electronic device is designed in which high integration, high performance, and miniaturization have been progressing, simple thermal analysis is performed at an upstream design stage, for example, in a state in which components to be used have been determined but the arrangement has yet to be determined. The detailed design policy and the like are determined based on the analysis result.

Technologies in the related arts are discussed in Japanese Laid-open Patent Publication No. 2005-140509, Japanese Laid-open Patent Publication No. 2011-243126, Japanese Laid-open Patent Publication No. 2004-94675, and Japanese Laid-open Patent Publication No. 2005-346527.

### SUMMARY

According to an aspect of the embodiments, a thermal analysis method includes: setting, by a processor, a first node to a first component and a plurality of second nodes to a second component from among a plurality of components of an electronic device, based on design information of the electronic device; assigning thermal information including a second temperature and a second heat quantity to each of the plurality of second nodes, based on a first temperature and a first heat quantity of each of a plurality of areas of the second component; calculating a first thermal resistance between adjacent nodes included in the plurality of second nodes, based on the thermal information; calculating a second thermal resistance between the first node and each of the plurality of second nodes, based on the design information to generate a thermal network including the first node, the plurality of second nodes, the first thermal resistance, and the second thermal resistance; and performing thermal analysis using the thermal network.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an exemplary thermal analysis method;

FIG. 2 is a diagram illustrating exemplary function blocks of a thermal analysis device;

FIG. 3 is a diagram illustrating an exemplary thermal analysis device;

FIG. 4 is a diagram illustrating an exemplary electronic device that is a thermal analysis target;

FIG. 5 is a diagram illustrating an exemplary thermal analysis method;

FIG. 6 is a diagram illustrating an exemplary setting of nodes;

FIG. 7 is a diagram illustrating an exemplary setting of thermal resistances;

FIG. 8 is a diagram illustrating an exemplary finite element method analysis model of a circuit board;

FIG. 9 is a diagram illustrating exemplary input data at the time of analysis by the finite element method;

FIG. 10 is a diagram illustrating an exemplary setting of nodes;

FIG. 11 is a diagram illustrating an exemplary assignment of thermal information;

FIG. 12 is a diagram illustrating exemplary nodes to which thermal information has been assigned;

FIG. 13 is a diagram illustrating an exemplary calculation of thermal resistances;

FIG. 14 is a diagram illustrating an exemplary thermal network after model coupling;

FIG. 15 is a diagram illustrating exemplary nodes that have been set to a circuit board having a plurality of layers;

FIG. 16 is a diagram illustrating an exemplary setting of nodes; and

FIG. 17 is a diagram illustrating an exemplary thermal network of a circuit board.

### DESCRIPTION OF EMBODIMENTS

As a thermal analysis method, for example, there is a method in which modeling of an electronic device is performed by a thermal network method.

When the modeling of an electronic device is performed by the thermal network method, a node is set for each component. For example, a thermal resistance between nodes is calculated based on a thermal conductance between corresponding components to generate a thermal network.

For example, components of the electronic device include a component the thermal conductivity of which is complex such as a circuit board. Therefore, when a thermal network is generated by setting a node for such a component similarly to the other components, the accuracy of the thermal analysis may be reduced.

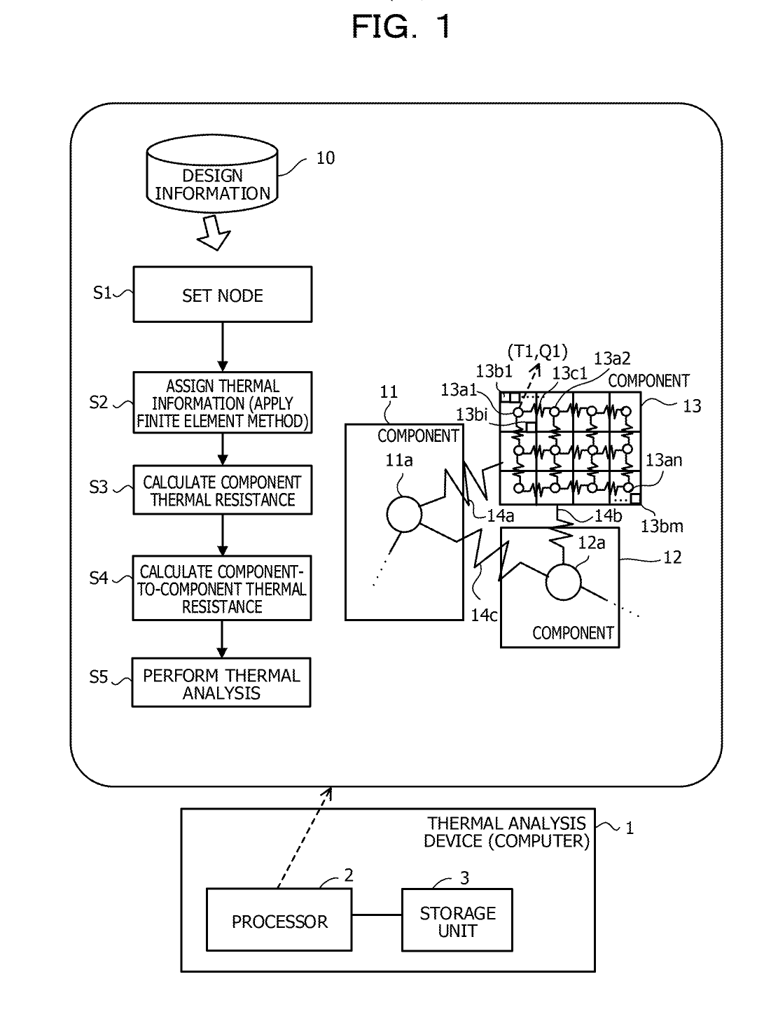

FIG. 1 is a diagram illustrating an exemplary thermal analysis method.

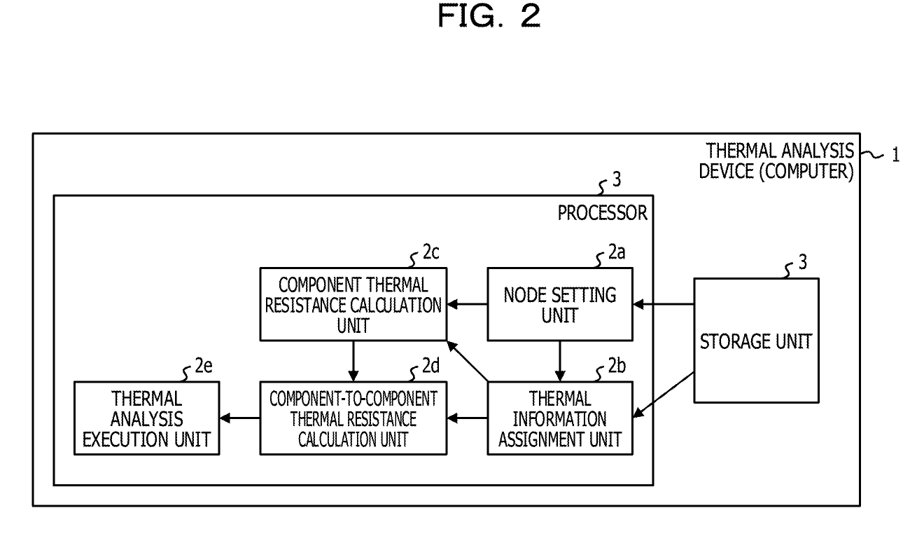

FIG. 2 is a diagram illustrating exemplary function blocks of a thermal analysis device. A thermal analysis device 1 is, for example, a computer, and includes a processor 2 and a storage unit 3. The processor 2 achieves functions of a node setting unit 2a, a thermal information assignment unit 2b, a component thermal resistance calculation unit 2c, a component-to-component thermal resistance calculation unit 2d, and a thermal analysis execution unit 2e as illustrated in FIG. 2, based on various data such as design information of the electronic device and programs stored in the storage unit 3. The storage unit 3 stores programs executed by the processor 2 and various data such as design information of the electronic device.

An exemplary thermal analysis method using the thermal analysis device 1 is described below with reference to FIGS. 1 and 2. In Operation S1, for example, the node setting unit 2a sets a plurality of nodes to a certain component from among a plurality of components and sets a single node to each of the other components based on design information 10 of the electronic device. For example, as illustrated in FIG. 1, nodes 11a and 12a are respectively set to components 11 and 12, and a plurality of nodes 13a1, 13a2, . . . , and 13an are set to a component 13. For example, the thermal conductivity of the component 13 may be more complex than those of the components 11 and 12. For example, when the components 11 and 12 are cases of the electronic device, the component 13 may be a circuit board or the like. In the setting of the plurality of nodes 13a1 to 13an to the component 13, for example, the component 13 is divided into a plurality of areas 13b1 to 13bm, and a single node is set for each of the plurality of areas. A plurality of nodes may be set to each of the components 11 and 12.

In Operation S2, based on the temperatures and heat quantities of the areas 13b1 to 13bm of the component 13, which have been calculated by the finite element method, the thermal information assignment unit 2b assigns thermal information including a temperature and a heat quantity to the nodes 13a1 to 13an. The respective temperatures and heat quantities of the areas 13b1 to 13bm of the component 13 may be calculated in advance and stored in the storage unit 3, or the calculation may be performed by the thermal information assignment unit 2b using the finite element method in Operation S2.

In FIG. 1, an example is illustrated in which thermal information (T1, Q1) is assigned to the node 13a1. Here, “T1” is an average value of the respective temperatures of the areas 13b1 to 13bi, and “Q1” is a total amount of the respective heat quantities of the areas 13b1 to 13bi.

When the sizes of the respective areas 13b1 to 13bi are different from each other, “T” may be set as a value obtained by dividing an integrated value of values that have been obtained by respectively multiplying the sizes of the areas 13b1 to 13bi by the temperatures of the areas 13b1 to 13bi, by an integrated value of the sizes of the areas 13b1 to 13bi.

In Operation S3, the component thermal resistance calculation unit 2c calculates a thermal resistance between adjacent nodes included in the nodes 13a1 to 13an based on the above-described thermal information (calculation of component thermal resistance). For example, when a thermal resistance 13c1 between the nodes 13a1 and 13a2 that are adjacent to each other is calculated, thermal information assigned to the nodes 13a1 and 13a2 is used.

In Operation S4, the component-to-component thermal resistance calculation unit 2d calculates thermal resistances between the nodes 11a, 12a, and a group of the nodes 13a1 to 13an, based on the design information 10 (calculation of a component-to-component thermal resistance). For example, the design information 10 includes information on a thermal conductance between the components 11 and 13 and a thermal conductance between the components 12 and 13, and the component-to-component thermal resistance calculation unit 2d calculates thermal resistances by obtaining the reciprocal of the thermal conductance.

In FIG. 1, a single thermal resistance 14a is illustrated between the components 11 and 13 in order to simplify the illustration, but actually a thermal resistance between the node 11a and each of the nodes 13a1 to 13an is calculated. Similarly, a single thermal resistance 14b is illustrated between the components 12 and 13 in order to simplify the illustration, but actually a thermal resistance between the node 12a and each of the nodes 13a1 to 13an is calculated.

In the process of Operation S4, a thermal resistance 14c between the nodes 11a and 12a is also calculated based on the design information 10 (for example, thermal conductance). In Operation S4, a thermal network is generated.

In Operation S5, the thermal analysis execution unit 2e performs thermal analysis to analyze a flow of the heat in the electronic device, for example, by using the thermal network that has been generated in Operation S4, thermal information assigned to the nodes 13a1 to 13an, heat quantities of the components 11 and 12, which are included in the design information 10, and the like.

The order of the processes is not limited to the above-described examples. The order of the above-described processes may be changed as appropriate, and the above-described processes may be executed in parallel. For example, setting of the nodes 11a and 12a and calculation of a thermal resistance between the nodes 11a and 12a in the components 11 and 12 may be performed independently from (in parallel with) setting of the nodes 13a1 to 13an, assignment of thermal information, and calculation of component thermal resistance in the component 13.

In the above-described thermal analysis method and thermal analysis device 1, for example, from among the components 11 to 13, the plurality of nodes 13a1 to 13an are set to the component 13, and thermal resistances between nodes are obtained based on thermal information that has been obtained by the finite element method to generate a thermal network. Therefore, a complex thermal conductivity of a component such as a circuit board is reflected in the thermal analysis, so that the analysis accuracy may be increased.

The analysis time may be reduced as compared with a case in which thermal analysis is performed for the whole electronic device by using the finite element method. The thermal analysis may be performed with a small information amount as compared with the case in which thermal analysis is performed for the whole electronic device by using the finite element method, which may be desirable for thermal analysis before detailed designing (at an upstream design stage).

There is a case in which the finite element method analysis has been performed on a circuit board or the like at the time of previous designing. The analysis time may be reduced by using the data (for example, information on the temperatures and heat quantities of the areas 13b1 to 13bm) at that time of previous designing.

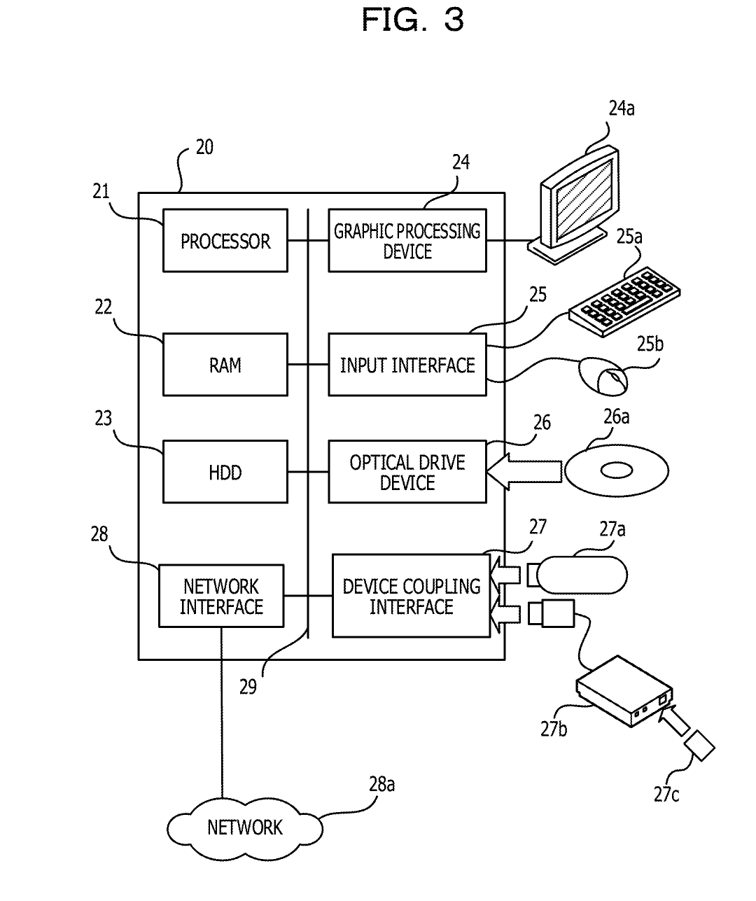

FIG. 3 is a diagram illustrating an exemplary thermal analysis device.

The thermal analysis device is, for example, a computer 20, and the whole device is controlled by a processor 21. A random access memory (RAM) 22 and a plurality of peripheral devices are coupled to the processor 21 through a bus 29. The processor 21 may be a multiprocessor. The processor 21 may be, for example, a central processing unit (CPU), a micro-processing unit (MPU), a digital signal processor (DSP), an application specific integrated circuit (ASIC), or a programmable logic device (PLD). In addition, the processor 21 may be a combination of two or more elements from among CPU, MPU, DSP, ASIC, and PLD.

The RAM 22 is used as a main storage device of the computer 20. At least some of programs of an operating system (OS) and application programs that the processor 21 is caused to execute are temporarily stored in the RAM 22. Various data desired for the processes by the processor 21 are stored in the RAM 22.

The peripheral devices coupled to the bus 29 may include a hard disk drive (HDD) 23, a graphics processing device 24, an input interface 25, an optical drive device 26, a device coupling interface 27, and a network interface 28.

The HDD 23 performs writing and reading of data for a built-in disk magnetically. The HDD 23 is used as an auxiliary storage device of the computer 20. Programs of an OS, application programs, and various data are stored in the HDD 23. As the auxiliary storage device, a semiconductor storage device such as a flash memory may be used.

A monitor 24a is coupled to the graphics processing device 24. The graphics processing device 24 causes an image to be displayed on a screen of the monitor 24a, in response to an instruction from the processor 21. As the monitor 24a, a display device using a cathode ray tube (CRT), a liquid crystal display device, or the like may be used.

A keyboard 25a and a mouse 25b are coupled to the input interface 25. The input interface 25 transmits a signal received from the keyboard 25a or the mouse 25b, to the processor 21. The mouse 25b is an exemplary pointing device, and another pointing device may be used instead of the mouse 25b. The other pointing device may include a touch panel, a tablet, a touch pad, and a trackball.

The optical drive device 26 reads data that has been recorded to an optical disk 26a using laser light or the like. The optical disk 26a is a portable recording medium to which data has been recorded to be read by reflection of light. The optical disk 26a includes a digital versatile disc (DVD), a DVD-RAM, a compact disc read only memory (CD-ROM), and a CD-recordable (R)/rewritable (RW).

The device coupling interface 27 is a communication interface used to couple a peripheral device to the computer 20. For example, a memory device 27a, a memory reader writer 27b, and the like may be coupled to the device coupling interface 27. The memory device 27a is a recording medium in which a communication function with the device coupling interface 27 is provided. The memory reader writer 27b is a device that performs writing of data to a memory card 27c or reading of data from the memory card 27c. The memory card 27c is a card-type recording medium.

The network interface 28 is coupled to a network 28a. The network interface 28 transmits and receives data to and from another computer or communication device through the network 28a.

Due to the above-described hardware configuration, the processing functions may be executed. To the thermal analysis device 1 illustrated in FIG. 1, hardware similar to that of the computer 20 illustrated in FIG. 3 may be applied.

The computer 20 may execute the processing functions, for example, by executing programs that have been recorded on a computer-readable recording medium. The programs in which processing contents that the computer 20 is caused to execute have been described may be recorded on various recording media. For example, the program that the computer 20 is caused to execute may be stored in the HDD 23. The processor 21 loads some of the programs in the HDD 23 to the RAM 22, and executes the programs. The programs that the computer 20 is caused to execute may be recorded on a portable recording medium such as the optical disk 26a, the memory device 27a, or the memory card 27c. The programs stored in the portable recording medium may be executed after having been installed in the HDD 23, for example, by the control of the processor 21. The processor 21 may read the programs from the portable recording medium directly and execute the programs.

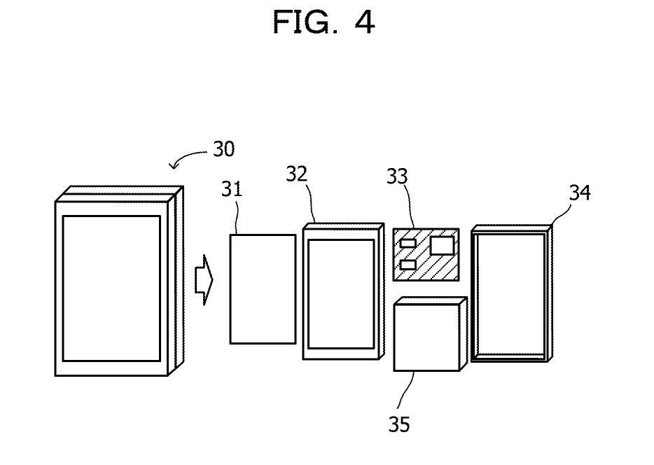

FIG. 4 is a diagram illustrating an exemplary electronic device that is a thermal analysis target. For example, an electronic device that is a thermal analysis target may be a smartphone 30. The thermal analysis target may be another electronic device.

As illustrated in FIG. 4, the smartphone 30 includes, for example, a liquid crystal 31, an upper case 32, a circuit board 33, a lower case 34, and a battery 35. The circuit board 33 is a complex implementation component as compared with the other components, and has a complex thermal conductivity. Therefore, in a case in which a thermal network is generated, when the modeling is performed using a single node, there is a probability that the thermal analysis accuracy is reduced undesirably. For example, the circuit board 33 may be a component to which a plurality of nodes is set.

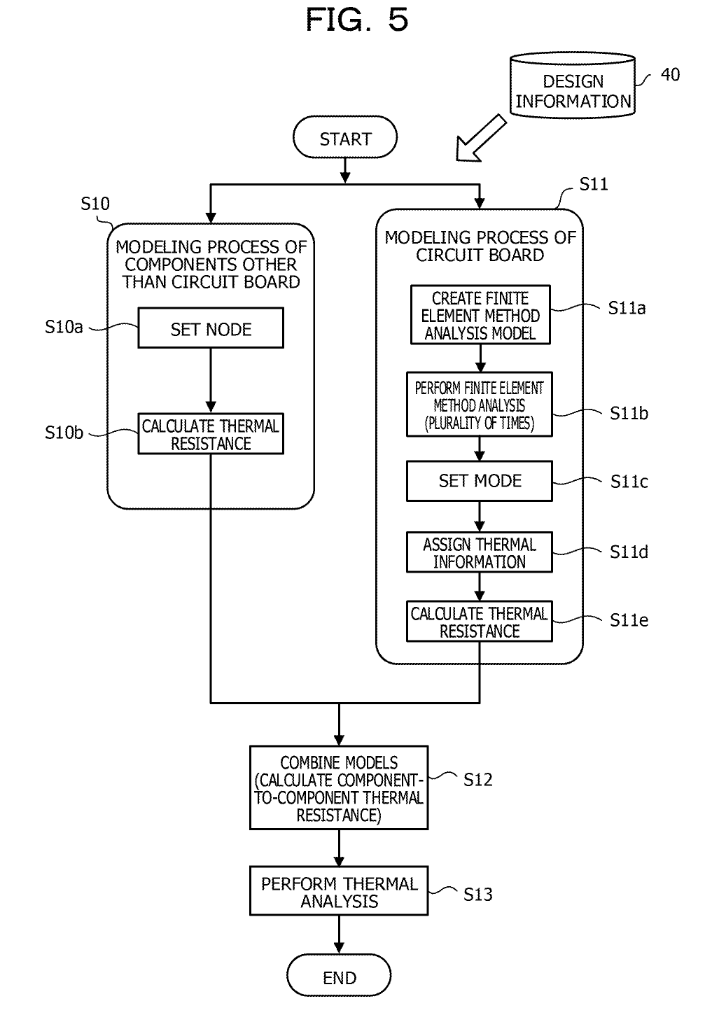

FIG. 5 is a diagram illustrating an exemplary thermal analysis method. In the computer 20 illustrated in FIG. 3, the processor 21 executes operations illustrated in FIG. 5, for example, by reading the programs stored in the HDD 23 and operating the programs on the RAM 22.

When the thermal analysis process starts, the processor 21 executes a modeling process of a component other than a circuit board (Operation S10) and a modeling process of the circuit board (Operation S11), for example, based on design information 40 of the smartphone 30, which is stored in the HDD 23. The processor 21 calculates a component-to-component thermal resistance, and combines the model of the component other than the circuit board and the model of the circuit board (Operation S12), executes thermal analysis using a thermal network that has been generated by the combination (Operation S13), and then ends the thermal analysis process.

In FIG. 5, Operations S10 and S11 are illustrated to be executed in parallel, but Operation S11 may be executed after Operation S10, or vice versa.

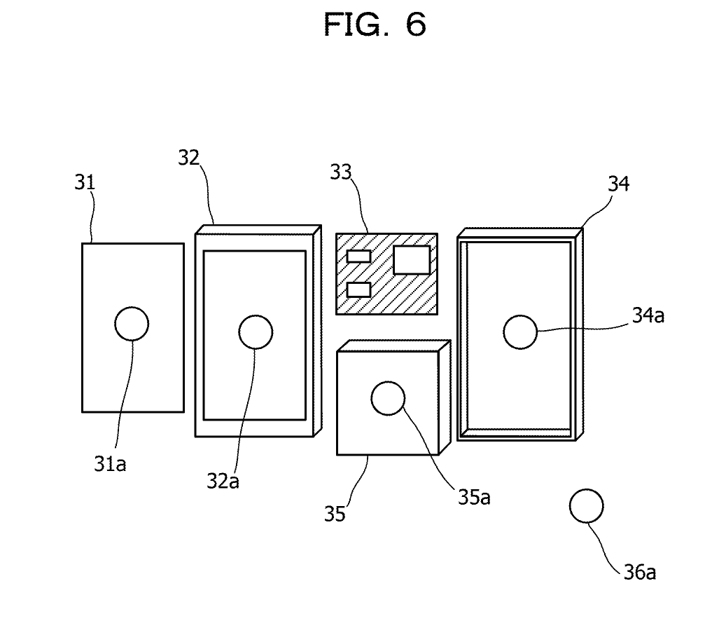

In Operation S10, node setting (Operation S10a), and thermal resistance calculation (Operation S10b) are performed. FIG. 6 is a diagram illustrating an exemplary node setting.

As illustrated in FIG. 6, nodes 31a, 32a, 34a, and 35a are respectively set to the liquid crystal 31, the upper case 32, the lower case 34, and the battery 35. In FIG. 6, a node 36a is set to the outside air. In FIG. 6, a node is not set to the circuit board 33.

In Operation S10b, the processor 21 calculates thermal resistances between the nodes 31a, 32a, 34a, 35a, and 36a, for example, based on information on a thermal conductance between the components, which is included in the design information 40.

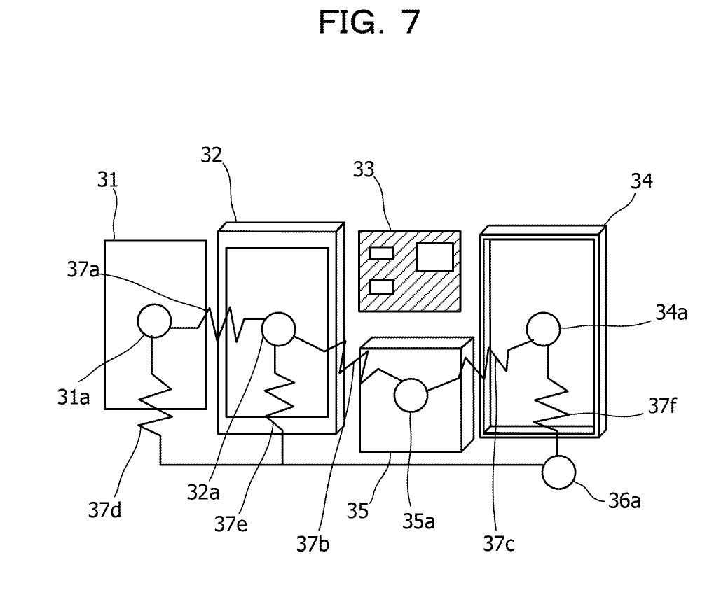

FIG. 7 is a diagram illustrating an exemplary setting of thermal resistances. As illustrated in FIG. 7, a thermal resistance 37a is indicated between the nodes 31a and 32a, a thermal resistance 37b is indicated between the nodes 32a and 35a, a thermal resistance 37c is indicated between the nodes 34a and 35a, and thermal resistances 37d, 37e, and 37f are respectively indicated between the node 36a and the corresponding nodes 31a, 32a, and 34a.

In Operation S11, finite element method analysis model creation (Operation S11a), finite element method analysis (Operation S11b), node setting (Operation S11c), thermal information assignment (Operation S11d), and thermal resistance calculation (Operation S11e) are performed.

In Operation S11a, the processor 21 obtains a three-dimensional model of the circuit board 33 included in the design information 40, and creates a finite element method analysis model by dividing the three-dimensional model into a plurality of areas (elements).

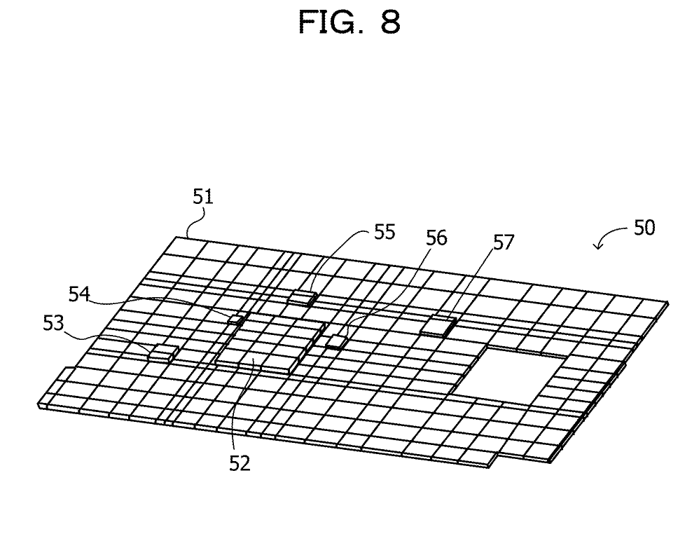

FIG. 8 is a diagram illustrating an exemplary finite element method analysis model of a circuit board. A finite element method analysis model 50 illustrated in FIG. 8 is obtained by dividing, into a plurality of elements, a three-dimensional model including a substrate 51 and various elements (integrated circuit (IC) chip and the like) 52, 53, 54, 55, 56, and 57 that are provided on the substrate 51 and each of which generates heat.

In Operation S11b, the processor 21 sets a boundary condition using the above-described finite element method analysis model 50, and performs finite element method analysis based on information on the material, the thermal conductivity, the heat capacity, the calorific value per unit time of each of the substrate 51 and the elements 52 to 57, which are included in the design information 40.

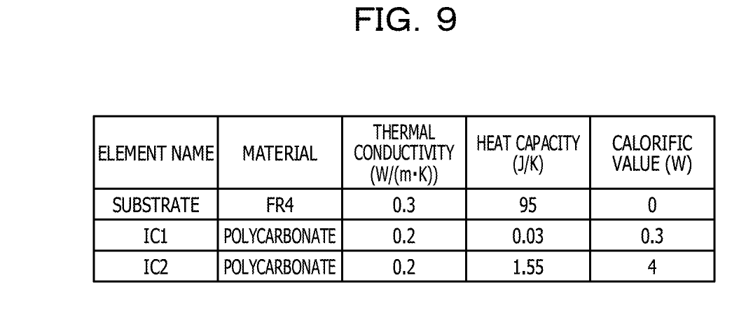

FIG. 9 is a diagram illustrating exemplary input data at the time of analysis by the finite element method. The input data includes, for example, flame retardant grade (FR) 4, a material such as polycarbonate, a thermal conductivity (in the unit “W/(m·K)”), a heat capacity (in the unit “J/K”), and a calorific value per unit time (in the unit “W”) in addition to an element name such as “substrate”, “IC1”, or “IC2”.

By the finite element method analysis, the heat quantity and the temperature of each of the elements is calculated. For the calculation process of a thermal resistance, the finite element method analysis may be performed a plurality of times under different conditions. For example, a calorific value per unit time of an IC or the like differs depending on the content of the operation, so that the finite element method analysis is performed a plurality of times using a different calorific value per unit time.

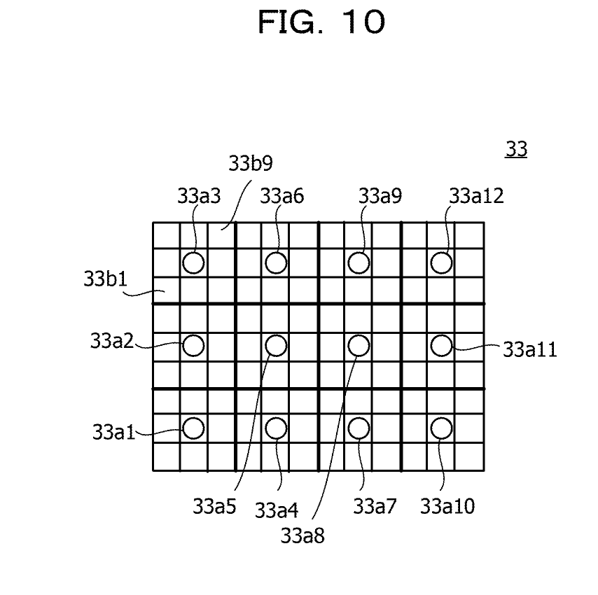

In Operation S11c, the processor 21 sets a plurality of nodes for the circuit board 33 as illustrated in FIG. 4. FIG. 10 is a diagram illustrating an exemplary node setting.

In FIG. 10, for simplification of explanation, an exemplary setting of a plurality of nodes 33a1 to 33a12 when assumed that the circuit board 33 has a single layer is illustrated. In FIG. 10, a single node is set for each group of nine elements of a finite element method analysis model. For example, a node 33a3 is set for a group of elements 33b1 to 33b9.

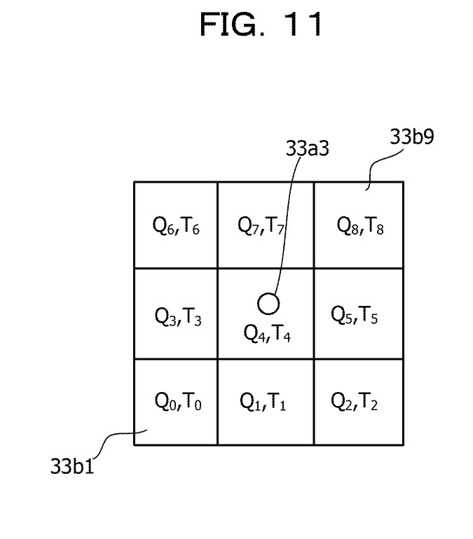

In Operation S11d, the processor 21 assigns thermal information to each of the nodes 33a1 to 33a12, based on the heat quantity and the temperature of each of the elements, which have been calculated by the finite element method analysis. FIG. 11 is a diagram illustrating an exemplary assignment of thermal information.

In FIG. 11, heat quantities Q₀ to Q₈, and temperatures T₀ to T₈ of the elements 33b1 to 33b9 in FIG. 10 are illustrated. The thermal information assigned to the node 33a3 is a total amount of the heat quantities Q₀ to Q₈ and an average value of the temperatures T0 to T8. When the sizes of the elements 33b1 to 33b9 are different from each other, a temperature of the node 33a3 is set as a value obtained by dividing an integrated value of values obtained by respectively multiplying the sizes of the elements 33b1 to 33b9 by the temperatures of the elements 33b1 to 33b9, by an integrated value of the sizes of the elements 33b1 to 33b9.

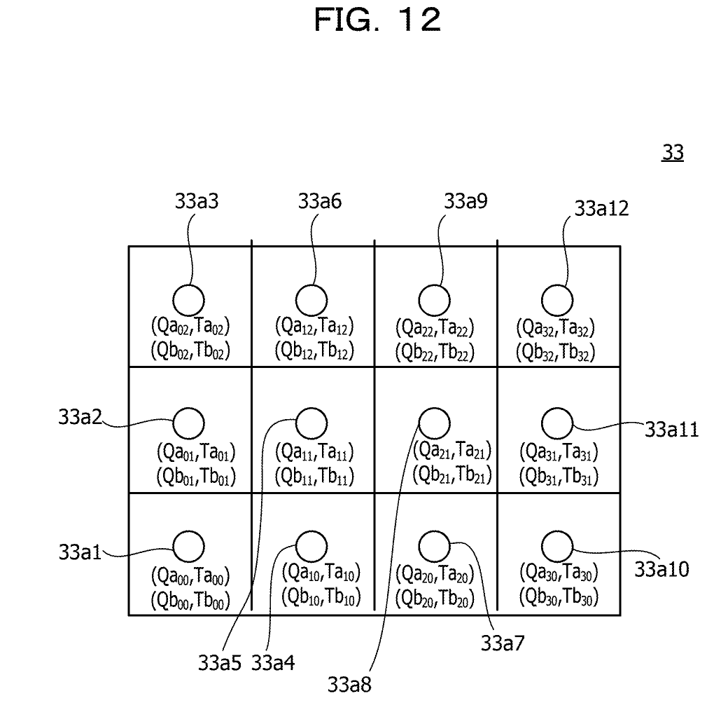

In order to calculate a thermal resistance, thermal information based on each of the plurality of results of the finite element method analysis is assigned to the nodes 33a1 to 33a12. FIG. 12 is a diagram illustrating exemplary nodes to which thermal information has been assigned.

FIG. 12 illustrates exemplary thermal information that has been assigned to the nodes 33a1 to 33a12 based on the results of the finite element method analysis that have been obtained under two conditions. For example, thermal information (Qa₀₂, Ta₀₂) and thermal information (Qb₀₂, Tb₀₂) that have been obtained by the finite element method analysis that has been performed under the two conditions are assigned to the node 33a3. “Qa₀₂, Qb₀₂” indicates the heat quantity, and “Taₘ, Tb₀₂” indicates the temperature.

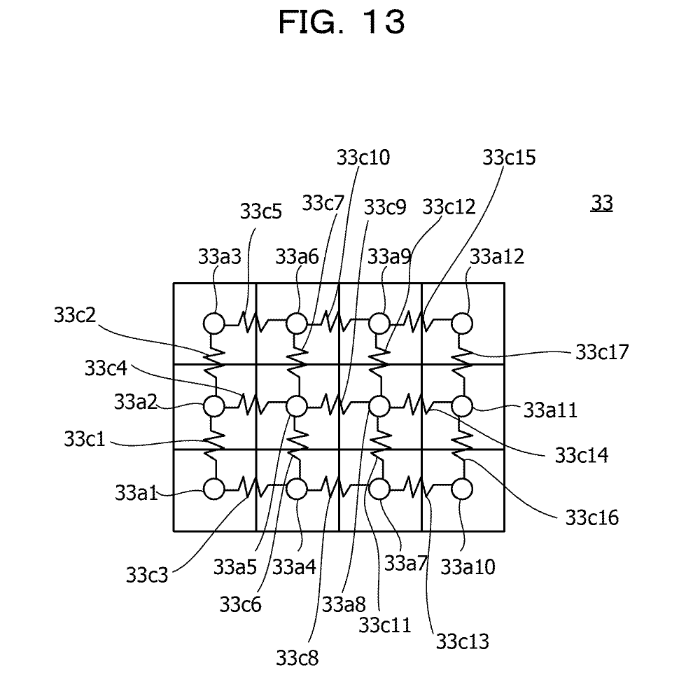

In Operation S11e, the processor 21 calculates a thermal resistance between the adjacent nodes 33a1 to 33a12 based on thermal information assigned to the adjacent nodes. FIG. 13 is a diagram illustrating an exemplary calculation of a thermal resistance.

In FIG. 13, thermal resistances 33c1 to 33c17 are illustrated between the adjacent nodes in the nodes 33a1 to 33a12. The processor 21 calculates the thermal resistances 33c1 to 33c17 so that the heat quantities and the temperatures included in thermal information assigned to the nodes 33a1 to 33a12 are reproduced.

For example, when assumed that the circuit board 33 has a single layer, the thermal resistances 33c1 to 33c17 are calculated by the following formulas.

$$\begin{matrix}\{ \begin{matrix}{Qa}_{00} = \frac{{Ta}_{10} - {Ta}_{00}}{{R}_{00 - 10}} + \frac{{Ta}_{01} - {Ta}_{00}}{{R}_{00 - 01}} \\ ⋮ \\ {Qa}_{11} = \frac{{Ta}_{01} - {Ta}_{11}}{{R}_{01 - 11}} + \frac{{Ta}_{10} - {Ta}_{11}}{{R}_{10 - 11}} + \frac{{Ta}_{21} - {Ta}_{11}}{{R}_{11 - 21}} + \frac{{Ta}_{12} - {Ta}_{11}}{{R}_{11 - 12}} \\ ⋮ \\ {Qa}_{32} = \frac{{Ta}_{22} - {Ta}_{32}}{{R}_{22 - 32}} + \frac{{Ta}_{31} - {Ta}_{32}}{{R}_{31 - 32}}\end{matrix} & ( 1 ) \\ \{ \begin{matrix}{Qb}_{00} = \frac{{Tb}_{10} - {Tb}_{00}}{{R}_{00 - 10}} + \frac{{Tb}_{01} - {Tb}_{00}}{{R}_{00 - 01}} \\ ⋮ \\ {Qb}_{11} = \frac{{Tb}_{01} - {Tb}_{11}}{{R}_{01 - 11}} + \frac{{Tb}_{10} - {Tb}_{11}}{{R}_{10 - 11}} + \frac{{Tb}_{21} - {Tb}_{11}}{{R}_{11 - 21}} + \frac{{Tb}_{12} - {Tb}_{11}}{{R}_{11 - 12}} \\ ⋮ \\ {Qb}_{32} = \frac{{Tb}_{22} - {Tb}_{32}}{{R}_{22 - 32}} + \frac{{Tb}_{31} - {Tb}_{32}}{{R}_{31 - 32}}\end{matrix} & ( 2 )\end{matrix}$$

The formulas (1) and (2) represent relationships between thermal information assigned to the nodes 33a1 to 33a12 illustrated in FIG. 12 and the thermal resistances 33c1 to 33c17 illustrated in FIG. 13. For example, “R₀₀₋₁₀” indicates the thermal resistance 33c3 between the nodes 33a1 and 33a4.

The thermal resistances 33c1 to 33c17 are calculated from the formulas (1) and (2). Next, Operation S12 is executed. The processor 21 calculates thermal resistances between the nodes 33a1 to 33a12 and each of the nodes 32a, 34a, and 35a, for example, based on information on thermal conductances included in the design information 40 between the circuit board 33, the upper case 32, the lower case 34, and the battery 35. As a result, the models (thermal networks) of the components other than the circuit board 33 and the circuit board 33, which have been generated in Operations S10 and S11, are combined to generate a new thermal network.

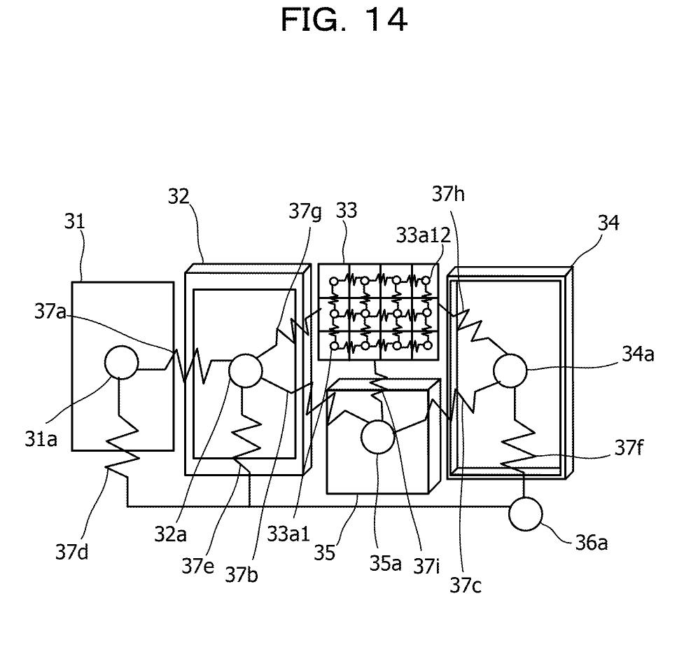

FIG. 14 is a diagram illustrating an exemplary thermal network after model coupling. Thermal resistances 37g, 37h, and 37i between a group of the nodes 33a1 to 33a12 and the respective nodes 32a, 34a, and 35a are illustrated.

In FIG. 14, a single thermal resistance 37g is illustrated between the node 32a and the group of the nodes 33a1 to 33a12 in order to simplify the illustration, but a thermal resistance is calculated between the node 32a and each of the nodes 33a1 to 33an. A single thermal resistance 37h is illustrated between the node 34a and the group of the nodes 33a1 to 33a12 in order to simplify the illustration, but a thermal resistance is calculated between the node 34a and each of the nodes 33a1 to 33an. Similarly, a single thermal resistance 37i is illustrated between the node 35a and the group of the nodes 33a1 to 33a12 in order to simplify the illustration, but actually the thermal resistance is calculated between the node 35a and each of the nodes 33a1 to 33an.

After that, in Operation S13, the processor 21 performs thermal analysis to analyze a flow of heat in the smartphone 30. In Operation S13, in addition to the generated thermal network, for example, thermal information assigned to the nodes 33a1 to 13a12, the calorific values and the like of the liquid crystal 31, the upper case 32, the lower case 34, and the battery 35, which are included in the design information 40, are used.

In the above-described thermal analysis method and thermal analysis device, the nodes 33a1 to 33a12 are set to the circuit board 33 from among the components (the liquid crystal 31, the circuit board 33, and the like) of the electronic device (smartphone 30). The thermal resistances between the nodes are obtained based on thermal information obtained by the finite element method to generate a thermal network. Therefore, a complex thermal conductivity in the circuit board 33 is reflected in the thermal analysis, and the analysis accuracy may be increased.

For example, in a case of the smartphone 30 where the calorific value in the CPU is 2.5 W, when a thermal network generated by setting a single node to the circuit board 33 is used, the analysis accuracy is about ±30° C. For example, when the thermal network generated by the above-described method is used, the analysis accuracy may be increased up to about ±10° C.

The analysis time may be reduced as compared with a case in which thermal analysis is performed on the whole smartphone 30 using the finite element method. The thermal analysis may be performed with a small information amount as compared with the case in which the thermal analysis is performed on the whole smartphone 30 using the finite element method, which may be desirable for thermal analysis before detailed designing (at an upstream design stage).

In the circuit board 33, the analysis time may be reduced by using data on which finite element method analysis has been performed at the time of previous designing. For example, the processor 21 may set a plurality of nodes to a component other than the circuit board 33 in addition to the circuit board 33, and calculate a thermal resistance based on thermal information obtained by the finite element method. As a result, the analysis accuracy may be further improved.

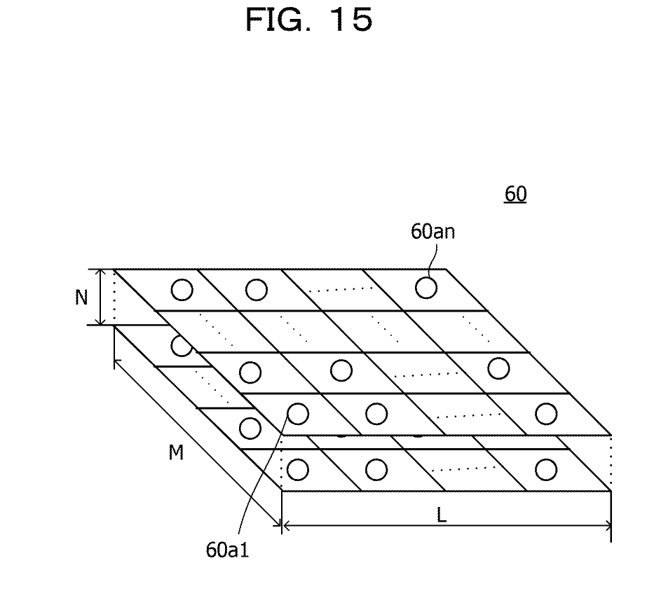

The thermal resistance may be calculated when the circuit board 33 has a single layer or when the circuit board 33 has a plurality of layers. FIG. 15 is a diagram illustrating exemplary nodes that have been set to a circuit board having a plurality of layers.

A circuit board 60 has N layers, and “L×M” nodes are set to each of the layers. For example, “n=L×M” nodes 60a1 to 60an are set to the top layer. The total number of nodes set to such a circuit board 60 is “L×M×N”. At that time, the number of thermal resistances is “3×L×M×N−L×M−M×N−N×L”.

In order to calculate thermal resistances using equations, equations the number of which is equal to or more than the number of thermal resistances are used. When “t” is set as the number of times by which the finite element method analysis is performed under different conditions, thermal resistances are calculated as long as relationships of the following formulas (3) are satisfied.

3×L×M×N−L×M−M×N−N×L≦t×L×M×N

(t−3)×L×M×N+L×M+M×N+N×L≧0 (3)

In a case in which “N=1” is satisfied, the formula (3) becomes “(t−2)×L×M+M+L≧0”, so that when “t=2” is satisfied, a thermal resistance is calculated regardless of “L” and “M”.

In a case in which “N≧2 (two or more layers)” is satisfied, when “t=3” is satisfied, “L×M+M×N+N×L≧0” is obtained, and a thermal resistance is calculated regardless of “L”, “M”, and “N”. For example, the processor 21 calculates a thermal resistance using thermal information obtained by each of the results of the finite element method analysis under three conditions.

A node of the circuit board 33 may be set for each group of elements the number of which is a certain number (nine in the example of FIG. 10). For example, at a location in which the temperature change is smaller than that of the other locations, the processor 21 may set a node for a group having a smaller number of elements than the other locations, based on the results of the finite element method analysis.

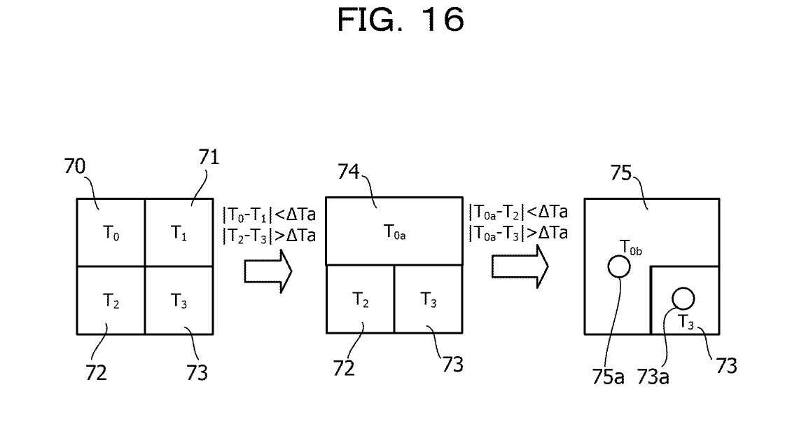

FIG. 16 is a diagram illustrating an exemplary node setting. In FIG. 16, elements 70, 71, 72, and 73 in the finite element method analysis and corresponding temperatures T₀, T₁, T₂, and T₃ of the elements 70 to 73 are illustrated. For example, when a temperature difference |T₀−T₁| between the elements 70 and 71 is smaller than a certain value ΔTa, the processor 21 couples the elements 70 and 71 and sets the elements 70 and 71 as a new element 74. The temperature T₀ₐ of the element 74 is, for example, an average value of the temperatures T₀ and T₁. When a temperature difference |T₂−T₃| between the elements 72 and 73 is larger than the certain value ΔTa, the processor 21 does not couple the elements 72 and 73.

When a temperature difference |T₀ₐ−T₂| between the element 74 that has been newly generated and the element 72 is smaller than the certain value ΔTa, the processor 21 couples the elements 72 and 74, and sets the elements 72 and 74 as a new element 75. The temperature T_{0b} of the element 75 is, for example, an average value of the temperatures T₀ₐ and T₂. When a temperature difference |T₀ₐ−T₃| between the elements 73 and 74 is larger than the certain value ΔTa, the processor 21 does not couple the elements 73 and 74. The processor 21 respectively sets nodes 73a and 75a to the elements 73 and 75.

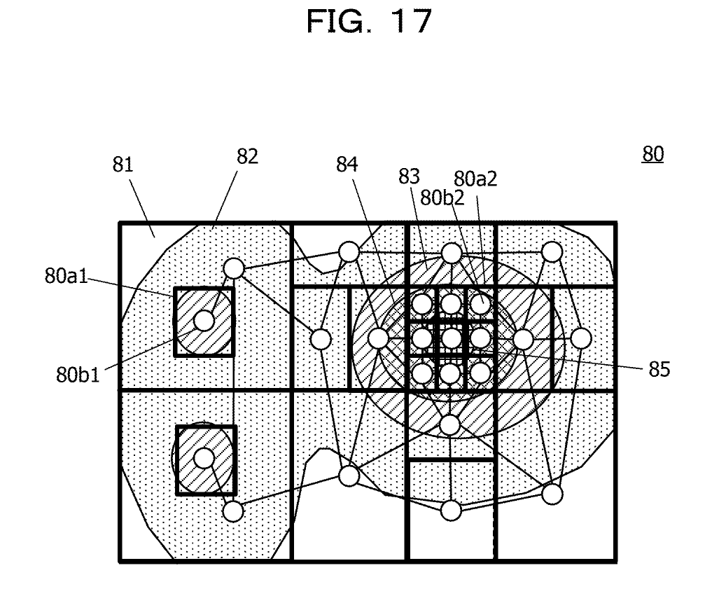

FIG. 17 is a diagram illustrating an exemplary thermal network of a circuit board. In FIG. 17, distribution of the temperatures on a circuit board 80, which has been obtained by the finite element method analysis, and a generated thermal network are illustrated. Areas 81, 82, 83, 84, and 85 indicate areas having different temperatures, and the temperature is high in order from the area 81 to 85. The node is set for each of the elements that have been obtained by the coupling process illustrated in FIG. 16. For example, a node 80b1 is set to an element 80a1, and a node 80b2 is set to an element 80a2.

In FIG. 17, a node-to-node thermal resistance is indicated by a straight line. As illustrated in FIG. 17, coupling of elements is hardly to occur at a location in which the temperature change is large, so that, small elements (for example, element 80a2) remain, and setting of a lot of nodes is performed.

In the above-described method, the accuracy of the thermal analysis is further improved when the processor 21 sets nodes and generates a thermal network, and the number of nodes is small at a location in which the temperature change is small, so that the analysis time may be reduced.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A thermal analysis method comprising:
setting, by a processor, a first node to a first component and a plurality of second nodes to a second component from among a plurality of components of an electronic device, based on design information of the electronic device;
assigning thermal information including a second temperature and a second heat quantity to each of the plurality of second nodes, based on a first temperature and a first heat quantity of each of a plurality of areas of the second component;
calculating a first thermal resistance between adjacent nodes included in the plurality of second nodes, based on the thermal information;
calculating a second thermal resistance between the first node and each of the plurality of second nodes, based on the design information to generate a thermal network including the first node, the plurality of second nodes, the first thermal resistance, and the second thermal resistance; and
performing thermal analysis using the thermal network.

2. The thermal analysis method according to claim 1, wherein
the first temperature and the first heat quantity of each of the plurality of areas of the second component are calculated by a finite element method.

3. The thermal analysis method according to claim 1, wherein
the second component is a circuit board.

4. The thermal analysis method according to claim 1, wherein
when a temperature difference between a first area and a second area adjacent to each other from among the plurality of areas is smaller than a first value, a third area is generated by coupling the first area and the second area, and one of the plurality of second nodes is set to the third area.

5. The thermal analysis method according to claim 1, wherein
the second temperature corresponds to an average value of the first temperatures of the plurality of areas, and
the second heat quantity corresponds to a total amount of the first heat quantities of the plurality of areas.

6. The thermal analysis method according to claim 1, wherein
when sizes of the plurality of areas are different with each other, the second temperature corresponds to a value obtained by dividing an integrated value of values obtained by respectively multiplying the sizes of the plurality of areas by the first temperatures of the plurality of areas, by an integrated value of the sizes of the plurality of areas.

7. A thermal analysis device comprising:
a processor configured to execute a thermal analysis program; and
a memory configured to store the thermal analysis program, wherein
the processor, based on the thermal analysis program, is configured to:
set a first node to a first component and sets a plurality of second nodes to a second component from among a plurality of components of an electronic device, based on design information of the electronic device;
assign thermal information including a second temperature and a second heat quantity to each of the plurality of second nodes, based on a first temperature and a first heat quantity of each of a plurality of areas of the second component;
calculate a first thermal resistance between adjacent nodes included in the plurality of second nodes, based on the thermal information;
calculate a second thermal resistance between the first node and each of the plurality of second nodes, based on the design information to generate a thermal network including the first node, the plurality of second nodes, the first thermal resistance, and the second thermal resistance; and
perform thermal analysis using the thermal network.

8. The thermal analysis device according to claim 7, wherein
the processor calculates the first temperature and the first heat quantity of each of the plurality of areas of the second component by a finite element method.

9. The thermal analysis device according to claim 7, wherein
the second component is a circuit board.

10. The thermal analysis device according to claim 7, wherein
the processor, when a temperature difference between a first area and a second area adjacent to each other from among the plurality of areas is smaller than a first value, generates a third area by coupling the first area and the second area, and sets one of the plurality of second nodes to the third area.

11. The thermal analysis device according to claim 7, wherein
the second temperature corresponds to an average value of the first temperatures of the plurality of areas, and
the second heat quantity corresponds to a total amount of the first heat quantities of the plurality of areas.

12. The thermal analysis device according to claim 7, wherein
when sizes of the plurality of areas are different with each other, the second temperature corresponds to a value obtained by dividing an integrated value of values obtained by respectively multiplying the sizes of the plurality of areas by the first temperatures of the plurality of areas, by an integrated value of the sizes of the plurality of areas.

13. A recording medium storing a computer-executable thermal analysis program, a computer to execute, based on the thermal analysis program, operations of:
setting a first node to a first component and setting a plurality of second nodes to a second component from among a plurality of components of an electronic device, based on design information of the electronic device,
assigning thermal information including a second temperature and a second heat quantity to the plurality of second nodes, based on a first temperature and a first heat quantity of each of a plurality of areas of the second component;
calculating a first thermal resistance between adjacent nodes included in the plurality of second nodes, based on the thermal information;
calculating a second thermal resistance between the first node and each of the plurality of second nodes, based on the design information to generate a thermal network including the first node, the plurality of second nodes, the first thermal resistance, and the second thermal resistance; and
performing thermal analysis using the thermal network.

14. The recording medium according to claim 13, wherein
the first temperature and the first heat quantity of each of the plurality of areas of the second component are calculated by a finite element method.

15. The recording medium according to claim 13, wherein
the second component is a circuit board.

16. The recording medium according to claim 13, wherein
when a temperature difference between a first area and a second area adjacent to each other from among the plurality of areas is smaller than a first value, a third area is generated by coupling the first area and the second area, and one of the plurality of second nodes is set to the third area.

17. The recording medium according to claim 13, wherein
the second temperature corresponds to an average value of the first temperatures of the plurality of areas, and
the second heat quantity corresponds to a total amount of the first heat quantities of the plurality of areas.

18. The recording medium according to claim 13, wherein
when sizes of the plurality of areas are different with each other, the second temperature corresponds to a value obtained by dividing an integrated value of values obtained by respectively multiplying the sizes of the plurality of areas by the first temperatures of the plurality of areas, by an integrated value of the sizes of the plurality of areas.
